(19) United States
(12) Patent Application Publication
(10) Pub. No.: US 2022/0306826 A1
(43) Pub. Date: Sep. 29, 2022

(54) HIGH PERFORMANCE URETHANE FOAM

(71) Applicant: LEAR CORPORATION, Southfield, MI (US)

(72) Inventors: Calton B. SPIVEY, Midland, MI (US); Robert D. DAWE, Sarnia (CA); Chiagoziem Mark ANEKE, Southfield, MI (US); Paul FIELDING, Farwell, MI (US); Jason DeMILLE, Southfield, MI (US); Gregory WETZEL, Southfield, MI (US); Jill GUNDERMAN, Clare, MI (US); Adam SHAW, Southfield, MI (US); Darius GEYER, Southfield, MI (US); Matthew PHILLIPS, Farwell, MI (US); Chi-Fan HSU, Novi, MI (US); Garrett UPLEGGER, Southfield, MI (US)

(21) Appl. No.: 17/212,570

(22) Filed: Mar. 25, 2021

(51) Int. Cl. C08J 9/12; C08J 9/00; C08G 18/73; C08G 18/66; C08G 18/08

(52) U.S. Cl. CPC C08J 9/125; C08J 9/0061; C08G 18/73; C08G 18/6674; C08G 18/14; C08J 2375/06; C08J 2375/08; C08J 2203/10; C08G 2101/00

(57) ABSTRACT

A method for forming polyurethane foams in a molding apparatus includes a step of directing one or more polyol compositions into a mold. Each of the one or more polyol compositions include a polyol, water, and a catalyst. The method also includes a step of directing an isocyanate composition into the mold to form a foamed polyurethane. The isocyanate composition includes one or more isocyanates. The one or more polyol compositions and the isocyanate composition is combined into a reaction composition. Characteristically, water concentration is in a range from 1.5 to 2 percent of the weight of the total reaction composition and the amount of isocyanate in the reaction composition is in a sufficient amount such that the isocyanate index is from about 83 to 98. A molded component made by the method is also provided.

### TECHNICAL FIELD

In at least one aspect, a high performance urethane foam suitable for automotive seat application is provided.

### BACKGROUND

Urethane foams are made by stoichiometrically reacting isocyanate with water and polyol (the polyol blend). The polyol isocyanate reaction yields urethane while the isocyanate water reaction yields CO² gas which lowers the density and creates the cellular structure of the foam. The isocyanate water reaction also yields biuret. Biuret contains secondary amines which can then further react with isocyanate to cross link and harden the foam. The hardness of the foam is adjusted by the percentage of iso mixed with the polyol blend such that the more isocyanate added, the harder the foam. When the iso mass ratio is such that 100 percent of the isocyanate and polyol blend is reacted a 100 Index is achieved.

The biuret; formed in the water reaction, allows for excess isocyanate to be used which reacts to further to increase the hardness of the foam. Excess water is often used beyond the requirement to achieve the target density to increase the hardness of the foam. This excess water creates a condition requiring the mold to be “burped” (TPR—Timed Pressure Release) during process to allow excess CO₂ to escape. This action lowers the mold pressure and reaction temperature when the water level used is beyond that required to hit the target density.

Traditionally, TM20 (80% TDI/20% MDI) urethane flexible foam are made in a four stream mixing head with the isocyanate being one stream and polyol blends the other three. These polyol streams are a base stream, a high-water stream, and a high polymer polyol stream (solids). The three polyol streams are used to control the density and hardness (ILD) of the foam. For example, more water results in lower density, more solids results in higher hardness, more water and more iso results higher hardness and lower density. The index; the stoiometric percentage of isocyanate required, for typical automotive foam can range from 75 to 115. This large range of index and water levels results in a broad spectrum of physical properties. These properties include, hysteresis, wet and dry set, tensile, tear and elongation, and the like.

Accordingly, there is a need for improved methods for making urethane foams.

### SUMMARY

In at least one aspect, the present invention a method for forming polyurethane foams in a molding apparatus is provided. The method includes a step of directing one or more polyol compositions into a mold. Each of the one or more polyol compositions include a polyol, water, and a catalyst. The method also includes a step of directing an isocyanate composition into the mold to form a foamed polyurethane. The isocyanate composition includes one or more isocyanates. The one or more polyol compositions and the isocyanate composition is combined into a reaction composition. Characteristically, water concentration is in a range from 1.5 to 2.0 percent of the weight of the total reaction composition and the amount of isocyanate in the reaction composition is in a sufficient amount such that the isocyanate index is from about 83 to 98.

In another aspect, a foamed molded component made by the methods set forth herein is provides. The foamed molded component includes a reaction product of a reaction composition including one or more isocyanates, one or more polyols, water, and a catalyst. Characteristically, water concentration is in a range from 1.5 to 2 percent of the weight of total the reaction composition and wherein the one or more isocyanates are in a sufficient about amount that the isocyanate index is from about 83 to 98. Advantageously, the reaction product is a polyurethane foam.

In some aspects, the present invention addresses the observation that although water controls density, it also contributes to creating hardness. It is also noted that changing isocyanate index changes the need amount of water in a blended pound of system mix. (i.e. more iso means less water). Any water used above the minimum to achieve density is contributing to hardness. Therefore, the present invention only uses the minimum amount of water needed to achieve the required density while maintaining the isocyanate index in the range of 83 to 98.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic of a molding apparatus for implementing a method for forming polyurethane foams.

FIG. 2. Plot of system water (water used per pound of molded foam) versus density.

FIG. 3. Plot of system ILD versus amount of DEOA.

FIGS. 4A and 4B. plots of the hysteresis versus ILD and wet set versus ILD.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “one or more” means “at least one” and the term “at least one” means “one or more.” The terms “one or more” and “at least one” include “plurality” and “multiple” as a subset. In a refinement, “one or more” includes “two or more.”

Throughout this application, where publications are referenced, the disclosures of these publications in their entireties are hereby incorporated by reference into this application to more fully describe the state of the art to which this invention pertains.

### Abbreviations

“1,3 PDO” means 1,3-propanediol.

“BDO” means 1,4-butanediol.

“CHDM” means cyclohexanedimethanol.

“DEOA” means diethanolamine.

“ILD” means indentation load force deflection.

“Quadrol” means (ethylenedinitrilo)tetra-2-propanol.

“TEOA” means triethanolamine.

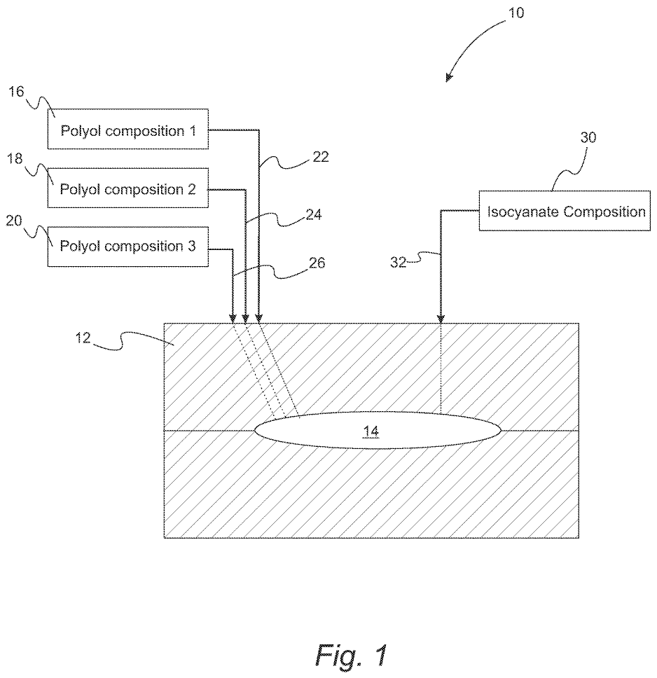

Referring to FIG. 1, a schematic of a molding apparatus for implementing a method for forming polyurethane foams is provided. Molding apparatus 10 includes a mold 12 having a mold cavity 14. The method includes a step of directing one or more polyol compositions 16, 18, and 20 into a mold, and in particular mold cavity 14. Each of one or more polyol compositions 16, 18, and 20 include a polyol, water, and a catalyst. The polyols and catalysts in polyol compositions 16, 18, and 20 can be the same or different. Typically, the one or more polyol compositions 16, 18, and 20 are directed into the mold (e.g., the mold cavity 14) via one or more polyol streams 22, 24, and 26.

Still referring to FIG. 1, an isocyanate composition 30 is directed into the mold (e.g., the mold cavity 14) to form a foamed polyurethane in the mold cavity 14. Typically, the isocyanate composition 30 directed into the mold (e.g., the mold cavity 14) via isocyanate stream 32. Typically, the isocyanate composition 30 includes one or more isocyanates. Therefore, the one or more polyol compositions and the isocyanate composition are combined into a reaction composition within mold cavity 14. Advantageously, the water concentration is in a range from 1.5 to 2 percent of the weight of the total reaction composition and the amount of isocyanate in the reaction composition is in a sufficient amount such that the isocyanate index is from about 83 to 98.

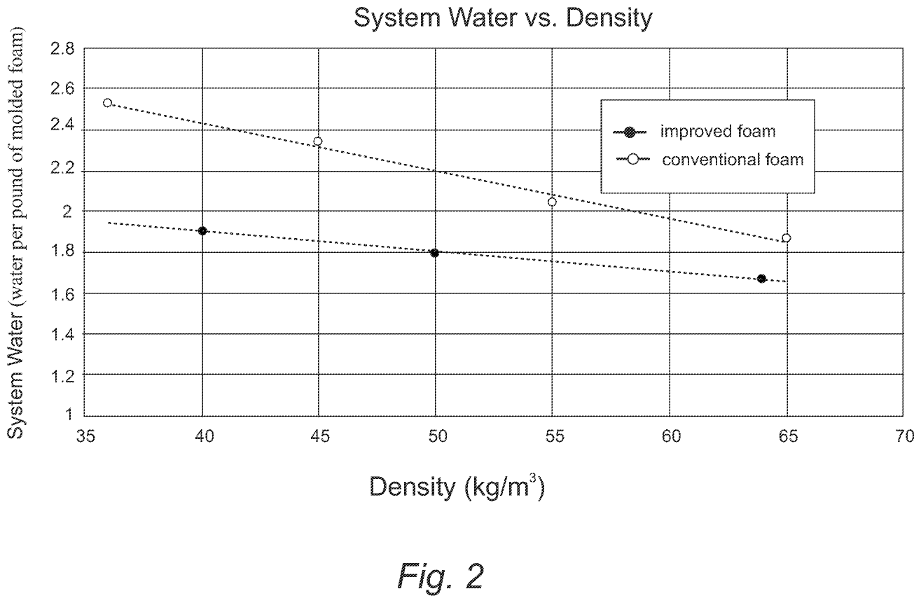

Advantageously, the amount of water directly affects the density of the polyurethane foam. For example, a functional relationship between the foam's density and water concentration; in the range from 1.5 to 2 percent of the total reaction composition, can be empirically determined (e.g., a calibration curve) from a series of experiments with known concentrations and reaction conditions. In a refinement, the functional relationship can be a line or a polynomial. Least squares analysis can be used for this purpose. In a refinement, the foam density of the foamed polyurethane is set to a value from to 35 kg/m³ to 70 kg/m³ by appropriate adjustment of the water level for a given set of concentrations and reaction conditions. FIG. 2 provides a plot of system water versus density for a polyurethane foam of the present invention (i.e., the improved foam) and for a prior art polyurethane foam (conventional foam). Clearly, the polyurethane foam of the present invention achieves the same density at lower water levels. For example, 50 kg/m\hat{ }3 foam can be made using about 20% less water than is conventionally used. Moreover, by using the minimum about of water, the method minimizes biuret formation.

In a variation, the one or more polyol compositions further include a low molecular weight chain hardener where the low molecular weight hardener has a molecular weight less than about 500 Daltons. In a refinement, the low molecular weight hardener has a molecular weight less than about 400 Daltons. In a further refinement, the low molecular weight hardener has a molecular weight less than about 300 Daltons. The low molecular weight hardener can be a chain extender or a cross linker. Examples of low molecular weight hardeners include, but are not limited to, 1,3-propanediol, 1,4-butanediol, cyclohexanedimethanol, diethanolamine, (ethylenedinitrilo)tetra-2-propanol, triethanolamine, and combinations thereof. The selection and amount of the hardener can affect the hardness of the foamed polyurethane. Therefore, a calibration chart that plots the ILD versus the hardener can be created. For example, a function relationship between hardener concentration and ILD can be empirically determined (e.g., a calibration curve) from a series of experiments with known concentrations and reaction conditions. In a refinement, the functional relationship can be a line or a polynomial.

As set forth above, the plurality of polyol streams 22, 24, and 26 are directed into the mold to transport the one or more polyol compositions. Each polyol stream includes a base polyol, a polymer polyol, and water. In a refinement, the plurality of polyol streams 22, 24, and 26 include a first polyol stream, a second polyol stream, and a third polyol stream that are directed to the mold (e.g., mold cavity 14). Table 1 provide examples of the polyol compositions for the three polyol streams presented as weight percents of the components. The polyols compositions can be plus or minus 30 percent of the values provided in Table 1.

TABLE 1
Polyol composition.

| | First polyol | Second polyol | Third polyol |
|---|---|---|---|
| | composition | composition | composition |
| Polyol | BASE | WATER | HARDENER |
| Designation | | | |
| Polymer | 80 | 67 | 55 |
| Polyol +/− 10 | | | |
| Base | 15 | 25 | 30 |
| Polyol +/− 10 | | | |
| Water +/− 1 | 1 | 5.5 | 1 |
| DEOA 0 | 1 | 1 | 8 |

In a variation, the base polyol includes a component selected from the group consisting of polymers with terminal hydroxyl groups a polyether polyol, copolymers with terminal hydroxyl groups, and combinations thereof. In a refinement, the base polyol is a polyether polyol or a polyester polyol. In another refinement, the base polyol is a high molecular weight polyether polyol. In still another refinement, the base polyol is a mixture of high molecular weight polyether polyols. The mixtures of high molecular weight polyether polyols can be a mixture of di- and tri-functional compounds that may have different molecular weight. In a refinement, the polyether polyols alone or in the mixture can have a number average molecular weight of from about 500 Daltons to 8000 Daltons. In a further refinement, the polyether polyols alone or in the mixture can have a number average molecular weight of from about 1,000 Daltons to 6,000 Daltons. Examples of di- and tri-functional materials include, but are not limited to polyethylene glycol, polypropylene glycol, glycerol-based polyether triols, trimethylolpropane-based polyether triols, and the like, and mixtures thereof. In some refinements, the polyether polyols have a hydroxyl number ranging from 30.0 to 33.0 mg KOH/g, a specific gravity of 1.03, a flash point of 171° C., and density of 8.59 lb/gal. In a variation, the polyoxyalkylene polyol has a hydroxyl number ranging from 18.2 to 22.2 mg KOH/g, a specific gravity of 1.6, a flash point of 213° C., and a density of 8.80 lb/gal. Suitable examples of the polyoxyalkylene polyol are HYPERLITE® 1629, HYPERLITE® 1650, HYPERLITE® E-824, HYPERLITE® E-863, HYPERLITE® E-960 and HYPERLITE® E-852 commercially available from Covestro located in Leverkusen, Germany.

In a variation, the polymer polyol is a graft polyol or a polyurea modified polyol. A particularly useful polymer can be a graft polyol that includes polymer segments having acrylonitrile residues and/or styrene residues. In a refinement, the acrylonitrile residues ardor styrene residues are present in an amount from about 40 to 44 weight percent of the weight of the graft polyol. It should also be appreciated that the amount of polymer-polyol can be used to tune the SAG factor. The higher the polymer-polyol concentration, the higher the SAG value.

The one or more isocyanates used in the methods set forth include a component selected from the group consisting of diisocyanates, triisocyanates, and combination thereof. Examples of diisocyantes include, but are not limited to, trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, pentamethylene 1,5-diisocyanate, and butylene 1,4-diisocyanate. Examples of triisocyantes include 1,3,5-triisocyanate, toluene 2,4,6-triisocyanate, triphenylemethane 4,4′,4″ triisocyanate, and combinations thereof. Therefore, the one or more isocyanates can include a component selected from the group consisting of trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, pentamethylene 1,5-diisocyanate, and butylene 1,4-diisocyanate, 1,3,5-triisocyanate, toluene 2,4,6-triisocyanate, triphenylemethane 4,4′,4″ triisocyanate, and combinations thereof.

As set forth above, the methods also use a catalyst. In a refinement, the catalyst is a tertiary amine. Examples of such catalyst include, but are not limited to, 1,4-diazabucyclo(2,2,2)octane, bis(2,2-dimethylamino)ethyl ether, N-ethylmorpholine, diethylenetriamine, triethylenediamine/glycol solutions, and combinations thereof.

In another embodiment, a molded component formed by the method set forth herein is provided. The molded component includes a reaction product of a reaction composition including one or more isocyanates, one or more polyols, water, and a catalyst, wherein water concentration is in a range from 1.5 to 2 percent of the weight of the total reaction composition and wherein the one or more isocyanates are in a sufficient about amount that the isocyanate index is from about 83 to 98, the reaction product being a polyurethane foam. In a refinement, the polyurethane foam has a density from about 35 kg/m³ to 70 kg/m³. Advantageously, the polyurethane foam can be included in a seat cushion, a headrest, or an arm rest.

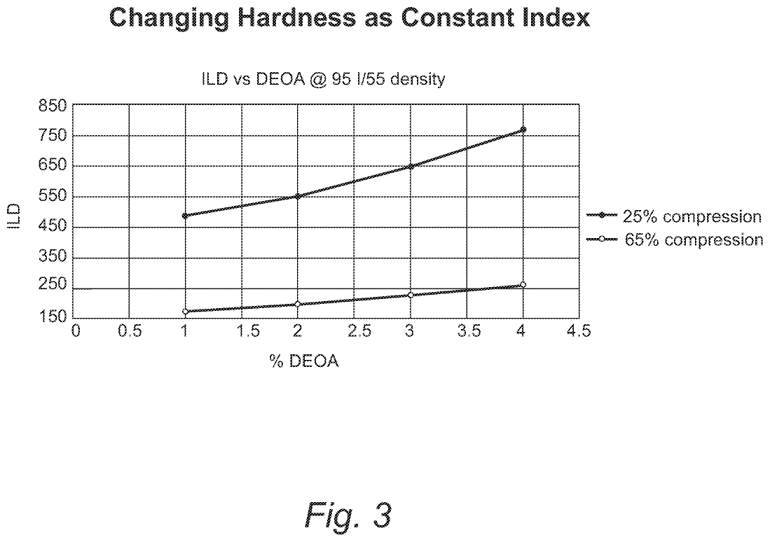

The details of the reaction product are the same as set forth above for the method for forming polyurethane foams in a molding apparatus. For example, the reaction composition can further include a low molecular weight hardener, the low molecular weight hardener having a molecular weight less than about 500 Daltons. FIG. 3 provides a plot of the ILD versus the concentration of the hardener DEOA at constant index. The hardness increase is obtained by adding the hardener to increase the isocyanate requirement keeping index in a small range. The indentation load force deflection are measured in accordance with JIS K 6400.

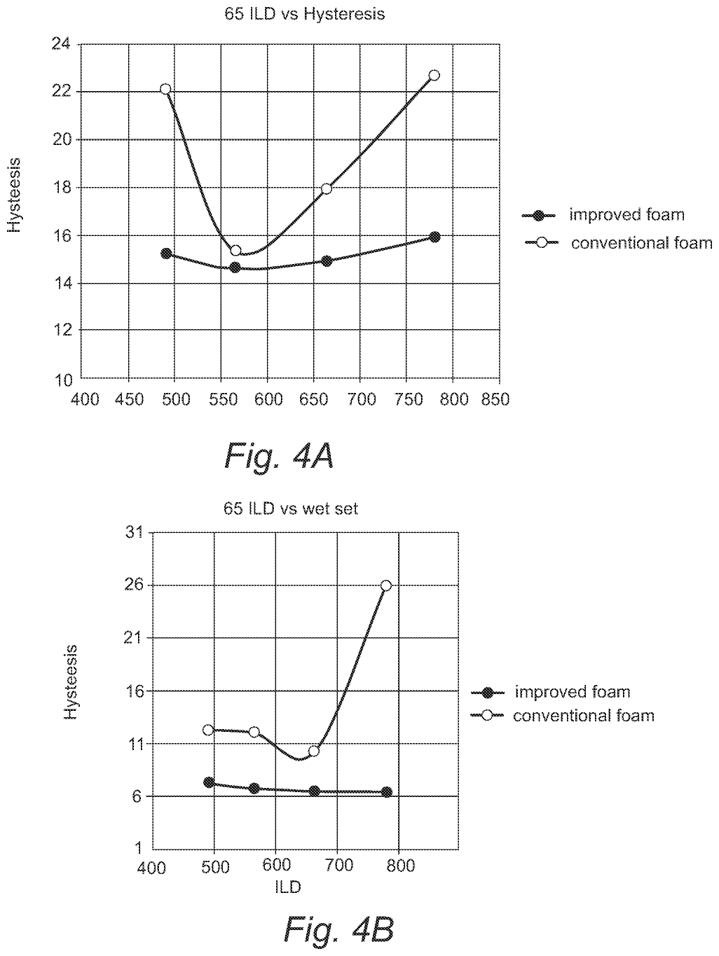

FIGS. 4A and 4B provides plots of the hysteresis versus ILD and wet set versus ILD at a contant index. (JIS K 6400). The figures show that the hysteresis and wet set is much lower than conventional foam for the same hardness. Property variations are less for the urethane foam made by the methods set forth above than for foams made by typical prior art composition. As is seen in FIG. 2, a 50 kg/m\hat{ }3 foam can be made using 1.8 parts of system water rather that the 2.2 parts typically used in the manufacture of conventional automotive polyurethane foams. FIGS. 4A & 4B shows that conventional methods create a broad range of physical properties owing to the wide range of index points (75,85,95,105) required. Contrastingly, managing the ILD with increasing isocyanate requirements at near constant index using the new method minimizes property variation as hardness increases.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for forming polyurethane foams in a molding apparatus, the method comprising:
directing one or more polyol compositions into a mold, each of the one or more polyol compositions including a polyol, water, and a catalyst; and
directing an isocyanate composition into the mold to form a foamed polyurethane, the isocyanate composition including one or more isocyanates, the one or more polyol compositions and the one or more isocynates being combined into a reaction composition,
wherein water concentration is in a range from 1.5 to 2 percent of the weight of the total reaction composition and wherein the amount of isocyanate in the reaction composition is in a sufficient amount such that the isocyanate index is from about 83 to 98.

2. The method of claim 1 wherein the one or more polyol compositions further include a low molecular weight hardener, the low molecular weight hardener having a molecular weight less than about 500 Daltons.

3. The method of claim 2 wherein the low molecular weight hardener is a chain extender or a cross linker.

4. The method of claim 2 wherein the low molecular weight hardener includes a component selected from the group consisting of 1,3-propanediol, 1,4-butanediol, cyclohexanedimethanol, diethanolamine, (ethylenedinitrilo)tetra-2-propanol, triethanolamine, and combinations thereof.

5. The method of claim 1 further comprising determining a function relationship between foam density of the foamed polyurethane and water concentration in the range from 1.5 to 2 percent of the total reaction composition.

6. The method of claim 5 wherein the foam density of the foamed polyurethane is set to a value from to 35 kg/m³ to 70 kg/m³.

7. The method of claim 1 wherein a plurality of polyol streams are directed into the mold to transport the one or more polyol compositions, each polyol stream including a base polyol, a polymer polyol, and water.

8. The method of claim 7 wherein a first polyol stream, a second polyol stream, and a third polyol stream are directed to the mold.

9. The method of claim 7 wherein the base polyol includes a component selected from the group consisting of polymers with terminal hydroxyl groups, a polyether polyol, copolymers with terminal hydroxyl groups, and combinations thereof.

10. The method of claim 7 wherein the base polyol is a polyether polyol or a polyester polyol.

11. The method of claim 7 wherein the polymer polyol is a graft polyol or a polyurea modified polyol.

12. The method of claim 7 wherein the polymer polyol is a graft polyol including polymer segments that include acrylonitrile residues and/or styrene residues.

13. The method of claim 12 wherein the acrylonitrile residues and/or styrene residues are present in an amount from about 20 to 44 weight percent of the weight of the graft polyol.

14. The method of claim 1 wherein the one or more isocyanates include a component selected from the group consisting of diisocyanate, triisocyanate, and combination thereof.

15. The method of claim 1 wherein the one or more isocyanates include a component selected from the group consisting of trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1,3,5-triisocyanate, toluene 2,4,6-triisocyanate, triphenylemethane 4,4′,4″ triisocyanate, and combinations thereof.

16. The method of claim 1 wherein the catalyst is a tertiary amine selected from the group consisting of 1,4-diazabucyclo(2,2,2)octane, bis(2,2-dimethylamino)ethyl ether, N-ethylmorpholine, diethylenetriamine, triethylenediamine/glycol solutions, and combinations thereof

17. A molded component comprising:
a reaction product of a reaction composition including one or more isocyanates, one or more polyols, water, and a catalyst, wherein water concentration is in a range from 1.5 to 2 percent of the weight of the total reaction composition and wherein the one or more isocyanates are in a sufficient about amount that the isocyanate index is from about 83 to 98, the reaction product being a polyurethane foam.

18. The molded component of claim 17 wherein the polyurethane foam is included in a seat cushion, a headrest, or an arm rest.

19. The molded component of claim 17 wherein the reaction composition further includes a low molecular weight hardener, the low molecular weight hardener having a molecular weight less than about 500 Daltons.
